(19) United States
(12) Patent Application Publication
(10) Pub. No.: US 2011/0317729 A1
(43) Pub. Date: Dec. 29, 2011

(54) CURRENT DRIVING DEVICE

(76) Inventors: Takeshi MATSUMOTO, Kyoto (JP); Kenichi Tatehara, Osaka (JP); Toshiyuki Shimada, Hyogo (JP); Yuichi Takahashi, Nara (JP)

(21) Appl. No.: 13/167,240

(22) Filed: Jun. 23, 2011

(30) Foreign Application Priority Data
Jun. 25, 2010 (JP) 2010-144661

(51) Int. Cl. H01S 3/10; G05F 1/10

(52) U.S. Cl. 372/38.02; 323/281

(57) ABSTRACT

A current driving device comprises; a three-terminal regulator configuration circuit operative as a three-terminal regulator which drops a voltage of a first electric power supply to a predetermined target output voltage in a state where a main terminal and a control terminal of a power transistor are connected to a main terminal connection terminal and a control terminal connection terminal, respectively; a voltage setting circuit which sets a control voltage corresponding to a target output voltage which is applied from the three-terminal regulator configuration circuit to the control terminal of the power transistor; and a voltage restricting circuit which is connected to the control terminal connection terminal and controls the control voltage applied to the control terminal of the power transistor so that the output voltage of the three-terminal regulator configuration circuit becomes a predetermined voltage or less, upon being supplied with the electric power from the first electric power supply.

The disclosure of Japanese Patent Application No. 2010-144661 filed on Jun. 25, 2010 including specification, drawings and claims are incorporated herein by reference in its entirety.

### BACKGROUND OF THE INVENTION

1. Field of the Invention

The present invention relates to a current driving device for controlling a driving current supplied to a driven device.

2. Description of the Related Art

There is known a current driving device for controlling a driving current supplied to a driven device such as a laser diode incorporated into a pick-up mechanism of an optical disc system. In particular, in a current driving device for a driven device such as a blue laser diode which requires a relatively high driving current (driving voltage), a voltage (e.g., 8˜10V) higher than a control voltage (e.g., 5V) for controlling the current driving device, is required as an output voltage supplied to a driving circuit for driving the driven device.

Japanese Laid-Open Patent Application Publication No. 2008-130109 discloses a configuration for generating the above driving voltage. In this configuration, there are provided a variable-voltage regulator for regulating and outputting a voltage for driving a laser diode, based on a voltage supplied from an external electric power supply for outputting a voltage (e.g., 12V) higher than a power supply voltage (e.g., 5V) used to drive the laser diode, and a controller for controlling the variable-voltage regulator. The controller controls the output voltage of the variable-voltage regulator to optimize the voltage for driving the laser diode. In this case, the variable-voltage regulator is driven by the external electric power supply. Under the state where the voltage of the external electric power supply is dropped to a target voltage, a feed-back control is executed to maintain the target voltage.

### SUMMARY OF THE INVENTION

However, in the configuration disclosed in Japanese Laid-Open Patent Application Publication No. 2008-130109, the variable-voltage regulator and the controller for controlling the variable-voltage regulator are necessary outside the pick-up mechanism. Therefore, this configuration has drawbacks that the number of components increases, a cost is high, or it is difficult to reduce a size of the system.

If a regulator circuit is incorporated into a laser driver to obviate such drawbacks, the regulator circuit is controlled by a control electric power supply for the laser driver. Because of this, the laser driver is supplied with electric powers from two electric power supplies, which are a control electric power supply (e.g., voltage source of 5V) for generating a control voltage of the laser driver (regulator circuit) and an output electric power supply (e.g., voltage source of 12V) for generating a driving voltage (output voltage of the regulator circuit) which is a higher than the control voltage. In this case, the order in which the two electric power supplies are turned ON (activated), is important. To be specific, if the output electric power supply is turned ON and the electric power is supplied from the output electric power supply to the regulator circuit before the control electric power supply is turned ON and the electric power is supplied from the control electric power supply to the regulator circuit, the regulator circuit outputs the voltage (e.g., 12V) output from the output electric power supply without being controlled, which might result in a situation in which the driving voltage becomes higher than a voltage (e.g., 10V) up to which the driving circuit can withstand and will damage the driving circuit and the driven device.

The present invention is directed to solving the above mentioned problems, and an object of the present invention is to provide a current driving device which can supply a driving voltage to a driving circuit stably and reduce the number of components.

To achieve the above objective, a current driving device of the present invention comprises a main terminal connection terminal connected to a power transistor, one main terminal of which is connected to a first electric power supply and the other main terminal of which is connected to the main terminal connection terminal; a control terminal connection terminal connected to a control terminal of the power transistor; a three-terminal regulator configuration circuit configured to change a control voltage corresponding to a target output voltage based on an output voltage, apply the changed control voltage to the control terminal of the power transistor to cause the power transistor to drop a voltage of the first electric power supply, feed-back control the dropped voltage so that the dropped voltage reaches the target output voltage, and output the controlled dropped voltage as the output voltage, in a state where the other main terminal and the control terminal of the power transistor are connected to the main terminal connection terminal and the control terminal connection terminal, respectively; a driving circuit configured to generate a driving current for driving a driven device using the output voltage; a voltage setting circuit which is connected to a second electric power supply which outputs a lower voltage than the first electric power supply and sets the control voltage corresponding to the target output voltage which is applied from the three-terminal regulator configuration circuit to the control terminal of the power transistor, using an electric power from the second electric power supply; and a voltage restricting circuit which is connected to the control terminal connection terminal and holds the control voltage applied to the control terminal of the power transistor so that the output voltage of the three-terminal regulator configuration circuit becomes a predetermined voltage or less, upon an electric power being supplied from the first electric power supply to the voltage restricting circuit.

In accordance with the above configuration, the power transistor is connected to the current driving device and thereby the three-terminal regulator is incorporated into the current driving device. And, the three-regulator configuration circuit executes the feed-back control using the voltage of the second electric power supply which outputs a lower voltage than the first electric power supply in such a manner that the control voltage based on the voltage output from the voltage setting circuit is applied to the control terminal of the power transistor to cause the power transistor to drop the voltage of the first electric power supply to the target output voltage. In addition, the voltage restricting circuit connected to the control terminal of the power transistor allows the control voltage to be maintained so that the output voltage of the three-terminal regulator configuration circuit becomes a predetermined voltage or less, when the first electric power supply is supplying the electric power. Therefore, even when the first electric power supply for generating the output voltage of the three-terminal regulator configuration circuit is turned ON before the second electric power supply for controlling the three-terminal regulator is turned ON, it is possible to prevent the output voltage of the three-terminal regulator configuration circuit from exceeding the voltage up to which the driving circuit can withstand. This makes it possible to supply the driving voltage to the driving circuit stably irrespective of the order in which the two electric power supplies are turned ON. In addition, the number of components can be reduced by incorporating the three-terminal regulator into the current driving device. Further, by providing the power transistor, among the constituents in the three-terminal regulator, outside the current driving device, it is possible to suppress an increase in the amount of heat generated within the current driving device or reduce an area of the integrated circuit constituting the current driving device.

The control terminal of the power transistor may be connected to the first electric power supply via a first resistive element; the voltage setting circuit may be configured to generate a set voltage based on a ground corresponding to the target output voltage using the electric power supplied from the second electric power supply, and apply the generated set voltage to the three-terminal regulator configuration circuit; the three-terminal regulator configuration circuit may include a first voltage dividing resistive circuit, one end of which is connected to the main terminal connection terminal and the other end of which is connected to a ground, the first voltage resistive circuit being configured to divide the output voltage; and a first control transistor, one main terminal of which is connected to the control terminal connection terminal, the other main terminal of which is applied with the set voltage of the voltage setting circuit, and a control terminal of which is applied with a voltage generated by voltage dividing in the first voltage dividing resistive circuit. In accordance with this, by connecting the main terminal of the power transistor to the main terminal connection terminal and the control terminal of the power transistor to the control terminal connection terminal, the three-terminal regulator can be formed easily.

The voltage restricting circuit may include: a second resistive element having one end connected to the control terminal connection terminal; a second control transistor, one main terminal of which is connected to the other end of the second resistive element and the other main terminal of which is connected to a ground; and a third control transistor, one main terminal of which is connected to the control terminal connection terminal via a third resistive element and to a control terminal of the second control transistor, and the other main terminal of which is connected to a ground, the third control transistor being turned ON to connect the control terminal of the second control transistor to a ground, when the voltage of the second electric power supply is not less than a predetermined voltage. In accordance with this, in a state where the second electric power supply is not turned ON or the voltage of the electric power supplied from the second electric power supply does not rise yet to a level at which the power transistor can be controlled after the second electric power supply is turned ON, the voltage of the first electric power supply is divided by the first resistive element and the second resistive element and the resulting voltage is applied to the control terminal of the power transistor. Therefore, by suitably determining a voltage division ratio preliminarily, the output voltage of the three-terminal regulator configuration circuit can be easily held at a voltage which is not more than a desired voltage (voltage smaller than the voltage up to which the driving circuit can withstand).

The voltage restricting circuit may include: a voltage detecting circuit configured to operate by an electric power supplied from the first electric power supply and detect a voltage supplied from the second electric power supply; a fourth resistive element having one end connected to the control terminal connection terminal; and a fourth control transistor, one main terminal of which is connected to the other end of the fourth resistive element, the other main terminal of which is connected to a ground, and a control terminal of which is connected to an output terminal of the voltage detecting circuit; wherein the voltage detecting circuit is configured to turn ON the fourth control transistor when the voltage detecting circuit detects a voltage less than a predetermined threshold voltage. In accordance with this, in a case where the first electric power supply is turned ON in a state where the second electric power supply is not turned ON or the voltage of the electric power supplied from the second electric power supply does not rise yet to a level at which the power transistor can be controlled after the second electric power supply is turned ON, the voltage of the first electric power supply is divided by the first resistive element and the fourth resistive element and the resulting voltage is applied to the control terminal of the power transistor. Therefore, by suitably determining a voltage division ratio preliminarily, the output voltage of the three-terminal regulator configuration circuit can be easily held at a voltage which is not more than a desired voltage (voltage smaller than the voltage up which the driving circuit can withstand).

The voltage restricting circuit may includes a clamp circuit connected to the control terminal connection terminal and configured to hold the control voltage applied to the control terminal of the power transistor at a predetermined voltage when the control voltage becomes the predetermined voltage or more. In accordance with the configuration of this embodiment, the control voltage applied to the control terminal of the power transistor is held at a predetermined voltage or less irrespective of whether the second electric power supply is turned ON or OFF. Therefore, with a simple configuration, the output voltage of the three-terminal regulator configuration circuit can be easily held at a desired voltage or less (voltage smaller than the voltage up to which the driving circuit can withstand).

The main terminal connection terminal, the control terminal connection terminal, the three-terminal regulator configuration circuit, the driving circuit, the voltage setting circuit and the voltage restricting circuit may be configured to form one integrated circuit. This makes it possible to reduce the number of components and reduce an area of the integrated circuit.

The driven device may be a laser diode and the driving circuit may be a laser current driving circuit for generating a driving current flowing through the laser diode.

The present invention is configured as described above and achieves the advantages that an output voltage can be supplied stably to a driving circuit, and the number of components can be reduced.

The above and further objects, features and advantages of the present invention will more fully be apparent from the following detailed description of preferred embodiments with accompanying drawings.

### BRIEF DESCRIPTION OF THE DRAWINGS

FIG. 1 is a schematic circuit diagram showing an overall configuration of a laser diode system to which a current driving device according to Embodiment 1 of the present invention is applied.

FIG. 2 is a schematic circuit diagram showing a configuration of a voltage setting circuit in the current driving device of FIG. 1.

FIG. 3 is a schematic circuit diagram showing an overall configuration of a laser diode system to which a current driving device according to Embodiment 2 of the present invention is applied.

FIG. 4 is a schematic circuit diagram showing an overall configuration of a laser diode system to which a current driving device according to Embodiment 3 of the present invention is applied.

FIG. 5 is a schematic circuit diagram showing a configuration of a voltage detecting circuit of the current driving device of FIG. 4.

FIG. 6 is a schematic circuit diagram showing an overall configuration of a laser diode system to which a current driving device according to Embodiment 4 of the present invention is applied.

### DETAILED DESCRIPTION OF THE PREFERRED EMBODIMENTS

Hereinafter, preferred embodiments of a current driving device of the present invention will be described with reference to the drawings. Throughout the drawings, the same or corresponding constituents and components are designated by the same reference symbols and will not be described repetitively in some cases. Hereinafter, description will be given of an example in which the current driving device is applied to a laser diode system in which a driven device is a laser diode and a driving circuit is a laser current driving circuit for generating a driving current flowing through the laser diode.

### Embodiment 1

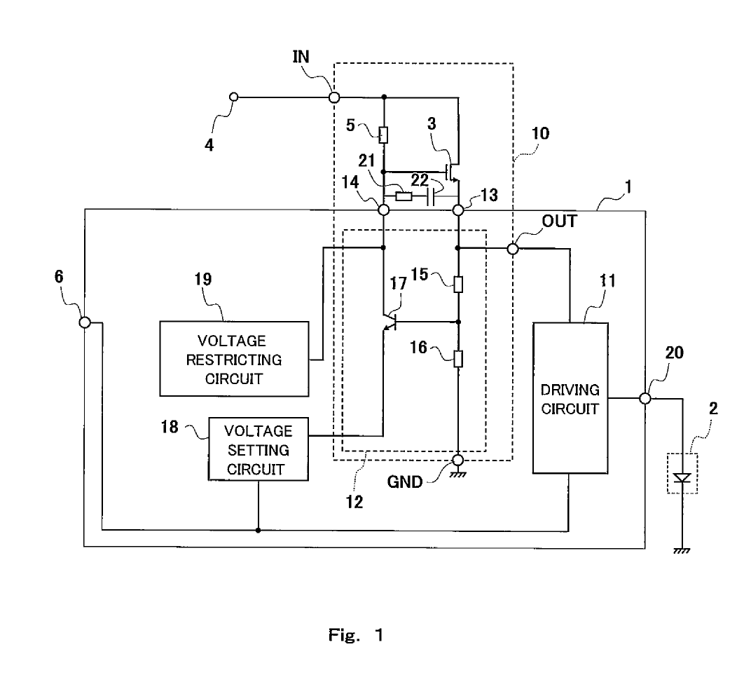

FIG. 1 is a schematic circuit diagram showing an overall configuration of a laser diode system to which a current driving device 1 according to Embodiment 1 of the present invention is applied. Referring now to FIG. 1, the current driving device 1 of this embodiment includes a driving circuit 11 for driving a laser diode 2 which is a driven circuit. The driving circuit 11 generates the driving current based on the output voltage from a three-terminal regulator described later to drive the laser diode 2. The laser diode 2 is connected to the current driving device 1 via a laser diode driving terminal 20.

The current driving device 1 includes a three-terminal regulator configuration circuit 12 for outputting an output voltage to the driving circuit 11. The three-terminal regulator configuration circuit 12 is connected to an external power transistor 3 to constitute a three-terminal regulator 10. To this end, the current driving device 1 has a main terminal connection terminal 13 and a control terminal connection terminal 14 via which the current driving device 1 is connected to the power transistor 3, as input terminals to the three-terminal regulator configuration circuit 12.

The power transistor 3 is constituted by, for example, an field effect transistor (FET). The power transistor 3 is configured to drop a voltage (e.g., power supply voltage of 12V) of a first electric power supply (voltage source) 4 connected to its one main terminal (e.g., drain terminal), to a predetermined target output voltage (e.g., 8.6V), in accordance with a signal input through its control terminal (e.g., gate terminal). The power transistor 3 may be constituted by a transistor (e.g., bipolar transistor, etc.) other than FET. The other main terminal (e.g., source terminal) of the power transistor 3 is connected to the main terminal connection terminal 13, while the control terminal of the power transistor 3 is connected to the control terminal connection terminal 14. A first resistive element 5 is provided between the first electric power supply 4 and the control terminal of the power transistor 3.

The three-terminal regulator 10 including the power transistor 3 and the three-terminal regulator configuration circuit 12 which are connected to each other is configured in such a manner that a portion thereof connected to the first electric power supply 4 serves as an input terminal IN, a portion thereof connected to the driving circuit 11 and outputting the output voltage dropped by the power transistor 3 serves as an output terminal OUT, and a portion thereof connected to a ground serves as a ground terminal GND. In this embodiment, the source terminal of the power transistor 3 is connected to the output terminal OUT.

The three-terminal regulator configuration circuit 12 includes a fifth resistive element 15 and a sixth resistive element 16 which are connected to the main terminal connection terminal 13 and constitute a first voltage dividing resistive circuit for dividing an output voltage. To a connection point of the fifth resistive element 15 and the sixth resistive element 16, the control terminal (e.g., base terminal) of a first control transistor 17 is connected. One main terminal (e.g., collector terminal) of the first control transistor 17 is connected to the control terminal connection terminal 14. The other main terminal (e.g., emitter terminal) of the first control transistor 17 is connected to a voltage setting circuit 18 for setting a target output voltage of the three-terminal regulator 10. The voltage setting circuit 18 is connected to a second electric power supply (voltage source) 6 which outputs a voltage (e.g., power supply voltage of 5V) lower than a voltage output from the first electric power supply 4, and provides a set voltage Vₛ on the basis of a ground to the other main terminal of the first control transistor 17, using an electric power supplied from the second electric power supply 6. The three-terminal regulator configuration circuit 12 applies to the control terminal of the power transistor 3 a control voltage corresponding to a target output voltage based on the set voltage Vₛ output from the voltage setting circuit 18. In other words, the voltage setting circuit 18 causes the three-terminal regulator configuration circuit 12 to apply, to the control terminal of the power transistor 3, the control voltage according to the set voltage Vₛ, thereby setting the output voltage of the three-terminal regulator 10 to the target output voltage.

In the above configuration, when the base-emitter voltage of the first control transistor 17 is V_{BE1}, the resistance value of the fifth resistive element 15 is R2, and the resistance value of the sixth resistive element 16 is R3, an output voltage V_{OUT} applied to the output terminal OUT is V_{OUT}=(V_{BE1}+Vₛ)·(R2+R3)/R3. Thus, the three-terminal regulator 10 including the power transistor 3 and the three-terminal regulator configuration circuit 12 stably outputs through the output terminal OUT, the voltage V_{OUT} which is generated by dividing a sum of the base-emitter voltage V_{BE1} of the first control transistor 17 and the set voltage Vₛ of the voltage setting circuit 18 by a ratio of the resistance value of the sixth resistive element 16 to the sum of the resistance value of the fifth resistive element 15 and the resistance value of the sixth resistive element 16.

In accordance with the above configuration, by connecting the main terminal of the power transistor 3 to the main terminal connection terminal 13 and the control terminal of the power transistor 3 to the control terminal connection terminal 14, the three-terminal regulator 10 can be formed easily. With the power transistor 3 connected to the current driving device 1, the three-terminal regulator 10 is incorporated into the current driving device 1. In this state, in the three-terminal regulator 10, using the voltage of the second electric power supply 6 which outputs a lower voltage than the first electric power supply 4, the control voltage corresponding to the target output voltage is changed based on the output voltage V_{OUT}, the changed control voltage is applied to the control terminal of the power transistor 3, the power transistor 3 drops the voltage of the first electric power supply 4, and the dropped voltage is feed-back controlled to reach the target output voltage and output as an output voltage V_{OUT} through the output terminal OUT.

It should be noted that in this embodiment, a resistive element 21 and a capacitor 22 are connected to each other between the other main terminal of the power transistor 3 and the control terminal of the power transistor 3, as a phase compensation circuit for absorbing an oscillation component of the three-terminal regulator 10.

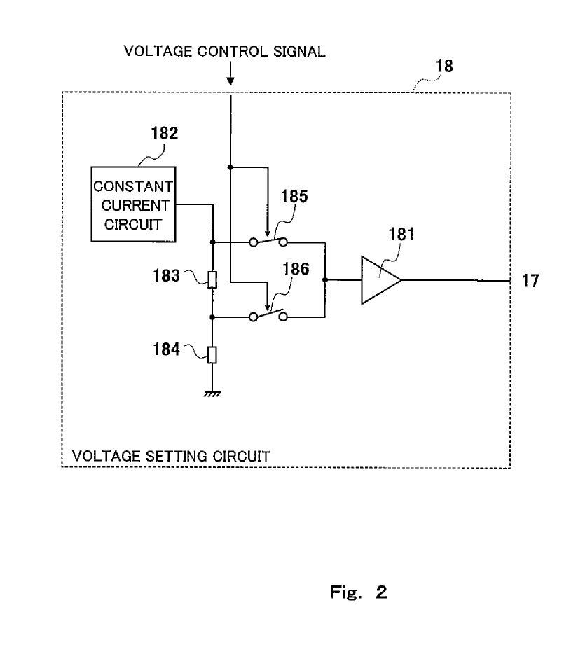

FIG. 2 is a schematic circuit diagram showing a configuration of the voltage setting circuit in the current driving device 1 of FIG. 1. Referring to FIG. 2, the voltage setting circuit 18 of this embodiment includes a buffer 181 connected to the other main terminal (e.g., emitter terminal) of the first control transistor 17, a constant current circuit 182 for outputting a predetermined constant current based on the electric power supplied from the second electric power supply 6, and a plurality of (two in FIG. 2) voltage setting resistive circuits (seventh resistive element 183 and eighth resistive element 184), which are provided between the constant current circuit 182 and the ground and connected in series with each other, and set predetermined voltages, respectively, a plurality of switch elements 185 and 186 one of which is selected to apply to the buffer 181, one of a plurality of voltages determined by the constant current output from the constant current circuit 182 and a plurality of resistance values of the voltage setting resistive circuits 183 and 184. One of the plurality of switch elements 185 and 186 is selectively turned ON (either resistive element 183 or 184 is connected to the buffer 181) in accordance with a voltage control signal from a control unit (not shown) provided inside or outside the current driving device 1. As the plurality of switch elements 185 and 186, various switch elements constituted by transistors such as FETs may be used. The buffer 181 has an ability to suction a current.

Now, it is supposed that in the above configuration, an equal voltage is input to and output from the buffer 181 and a base current of the first control transistor 17 is substantially zero. When the current output from the constant current circuit 182 is Ia, and the resistance values of the resistive elements 183 and 184 are R8 and R9, respectively, the set voltage Vₛ which is the output voltage of the voltage setting circuit 18 is Vₛ=Ia·(R8+R9) if only the switch element 185 is turned ON, and Vₛ=Ia·R9 if only the switch element 186 is turned ON. Therefore, by switching between ON and OFF of the switching elements 185 and 186, the value of the output voltage V_{OUT} of the three-terminal regulator configuration circuit 12 is switched between two levels. By increasing the voltage setting resistive circuits 183 and 184 and the switch elements 185 and 186 in number, it is possible to implement the current driving device 1 capable of switching the value of the output voltage V_{OUT} among three or more levels. Alternatively, the constant current circuit 182 and one resistive element may generate one set voltage Vₛ.

In this embodiment, the current driving device 1 further includes a voltage restricting circuit 19 which is connected to the control terminal connection terminal 14, and maintains the control voltage applied to the control terminal of the power transistor 3 so that the output voltage V_{OUT} of the three-terminal regulator configuration circuit 12 becomes a predetermined voltage V_{c} or less, upon the electric power being supplied from the first electric power supply 4 to the voltage restricting circuit 19.

Firstly, discussion will be given of a case where the voltage restricting circuit 19 is omitted. During the operation of the three-terminal regulator 10, the voltage setting circuit 18 is driven by the electric power from the second electric power supply 6, and thereby a current flows from the input terminal IN to the buffer 181 of the voltage setting circuit 18. Since the power supply voltage of the first electric power supply 4 is dropped based on the resistance value R1 of the first resistive element 5 and the dropped voltage is applied to the control terminal of the power transistor 3, the power transistor 3 generates the output voltage V_{OUT} according to the dropped voltage.

On the other hand, in a case where the power supply voltage (e.g., 12V) is applied from the first electric power supply 4 to the power transistor 3 in a state where the voltage setting circuit 18 is not supplied with the electric power from the second electric power supply 6, the plurality of switching elements 185 and 186 for switching the set voltage Vₛ are both turned OFF, and a current is not suctioned into the buffer 181 in the voltage setting circuit 18 (output of the voltage setting circuit 18 becomes a high impedance state). Therefore, no voltage is applied to the first control transistor 17, and the operation of the regulator 10 is disenabled. As a result, no current flows through the first resistive element 5. Since the power supply voltage (e.g., 12V) of the first electric power supply 4 is applied to the control terminal of the power transistor 3 without being dropped by the resistive element 5, the power transistor 3 operates in a saturated range and the output voltage V_{OUT} at the output terminal OUT is the voltage (e.g., about 11V) which is generated by dropping the voltage of the first electric power supply 4, by a gate-source voltage (e.g., about 1V), in a case where the driving circuit 11 has an internal circuit configuration (e.g., circuit in which a resistor is connected to the output terminal OUT and the ground terminal GND) which requires a current with respect to the output voltage V_{OUT}. On the other hand, in a case where the driving circuit 11 has an internal circuit configuration which does not require a current with respect to the output voltage V_{OUT}, the power transistor 3 operates in a non-saturated range, and a voltage drop could correspond to a drain-source ON-resistance component of the power transistor 3, so that the voltage of about 12V which is the voltage of the first electric power supply 4, is output as the output voltage V_{OUT}, without modifying it. For example, when the voltage up to which the driving circuit 11 driven with about 8.6V in a normal operation, can withstand, is 10V, a failure or damage will occur in the driving circuit 11, if a voltage of 11V is applied to the driving circuit 11, which arises a problem. As should be appreciated, if the voltage restricting circuit 19 is not provided, the driving circuit 11 and the laser diode 2 would fail or be damaged if the second electric power supply 6 is turned ON before the first electric power supply 4 is turned ON.

As a solution to the above, in this embodiment, the voltage restricting circuit 19 is connected to the control terminal connection terminal 14. This allows the control voltage to be maintained so that the voltage at the output terminal OUT of the three-terminal regulator configuration circuit 12 becomes the predetermined voltage V_{c} (e.g., 10V) or less when the first electric power supply 4 is supplying the electric power to the three-terminal regulator configuration circuit 12. Therefore, even if the first electric power supply 4 for generating the output voltage V_{OUT} is turned ON before the second electric power supply 6 for controlling the three-terminal regulator configuration circuit 12 is turned ON, it is possible to prevent the output voltage V_{OUT} of the three-terminal regulator configuration circuit 12 from exceeding the voltage up to which the driving circuit 11 can withstand. Therefore, it is possible to supply the driving voltage to the driving circuit 11 stably irrespective of the order in which the two electric power supplies 4 and 6 are turned ON.

As described above, since the problem associated with the order in which the two electric power supplies 4 and 6 are turned ON, which arises when the three-terminal regulator 10 is incorporated into the current driving device 1, can be solved by providing the voltage restricting circuit 19, the three-terminal regulator 10 can be incorporated into the current driving device 1. Therefore, the number of components in the current driving device 1 can be reduced. Further, by providing the power transistor 3, among the constituents in the three-terminal regulator 10, outside the current driving device 1, it is possible to suppress an increase in the amount of heat generated within the current driving device 1 or reduce an area of the integrated circuit constituting the current driving device 1.

Moreover, in the above configuration, the main terminal connection terminal 13, the control terminal connection terminal 14, the three-terminal regulator configuration circuit 12, the driving circuit 11, the voltage setting circuit 18 and the voltage restricting circuit 19 are configured into one integrated circuit. This makes it possible to reduce the number of components and reduce an area of the integrated circuit.

### Embodiment 2

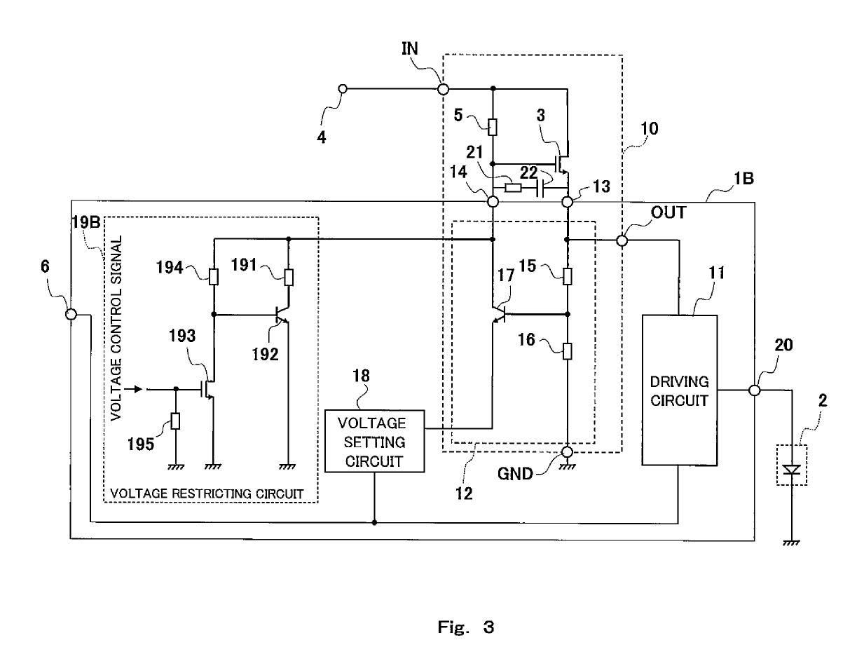

Next, Embodiment 2 of the present invention will be described with reference to FIG. 3. FIG. 3 is a schematic circuit diagram showing an overall configuration of a laser diode system to which a current driving device 1B according to Embodiment 2 of the present invention is applied. In Embodiment 2, the same constituents as those in Embodiment 1 are designated by the same reference symbols and will not be described repetitively.

Referring to FIG. 3, the current driving device 1B of this embodiment is different from the current driving device 1A of Embodiment 1 in that a voltage restricting circuit 19B includes a second resistive element 191 having one end connected to the control terminal connection terminal 14, a second control transistor 192, one main terminal (e.g., collector terminal) of which is connected to the other end of the second resistive element 191 and the other main terminal (e.g., emitter terminal) of which is connected to a ground, and a third control transistor 193, one main terminal (e.g., drain terminal) of which is connected to the control terminal connection terminal 14 via a third resistive element 194, and the other main terminal (e.g., source terminal) of which is connected to a ground, and which is turned ON and connects the control terminal (e.g., base terminal) of the second control transistor 192 to a ground, when the voltage of the second electric power supply 6 is not less than a predetermined voltage. In this embodiment, the second control transistor 192 is constituted by a bipolar transistor, and the third control transistor 193 is constituted by a FET.

To be specific, the second resistive element 191, one end of which is connected in series with the first resistive element 5 via the control terminal connection terminal 14 and the other end of which is connected to one main terminal (collector terminal) of the second control transistor 192. Thus, the first resistive element 5 and the second resistive element 191 constitute a second voltage dividing resistive circuit. One end of a ninth resistive element 195 is connected to the control terminal of the third control transistor 193, while the other end of the ninth resistive element 195 is connected to a ground. A voltage control signal from a control unit (not shown) provided inside or outside of the current driving device 1 is input to the control terminal of the third control transistor 193. To be specific, during a non-driving state of the driving circuit 11, a signal of a first voltage level L is input to the control terminal of the third control transistor 193, while during a driving state of the driving circuit 11, a signal of a second voltage level H higher than the first voltage level L is input to the control terminal of the third control transistor 193. The third control transistor 193 is turned OFF, upon reception of the signal of the first voltage level L, and is turned ON, upon reception of the signal of the second voltage level H. When the signal of the second voltage level H is input to the control terminal of the third control transistor 193, the electric potential of the control terminal of the second control transistor 192 becomes a ground potential.

In the above configuration, in a state where the second electric power supply 6 is not turned ON or the voltage of the electric power supplied from the second electric power supply 6 does not rise yet to a level at which the power transistor 3 can be controlled after the second electric power supply 6 is turned ON, the control terminal of the third control transistor 193 is held at the ground potential via the ninth resistive element 195, as long as the voltage control signal is not input to the control terminal of the third control transistor 193. Therefore, the third control transistor 193 is turned OFF. Thereupon, the third resistive element 194 pulls up the electric potential at the control terminal of the second control transistor 192 and a current flows through the control terminal of the second control transistor 192 via the third resistive element 194, causing the second control transistor 192 to be turned ON. Although a collector-emitter voltage is generated in the second control transistor 192, it is saturated (saturated voltage: about 200 mV) and is a substantially constant value which is a negligible magnitude. Thereby, a voltage generated by substantially dividing the voltage of the first electric power supply 4 by the second voltage dividing resistive circuit, is applied to the control terminal of the power transistor 3. The power transistor 3 drops the voltage generated by the voltage dividing in the second voltage dividing resistive circuit, by a threshold voltage of the power transistor 3, and the dropped voltage is output as the output voltage V_{OUT} of the three-terminal regulator configuration circuit 12.

As described above, during a non-driving state where the electric power of the second electric power supply 6 is not supplied to the current driving device 1 (voltage restricting circuit 19B), the voltage of the first electric power supply 4 is divided by the second voltage dividing resistive circuit. Therefore, by suitably determining a voltage division ratio (ratio between the resistance value of the first resistive element 5 and the resistance value of the second resistive element 191) preliminarily, the output voltage V_{OUT} of the three-terminal regulator configuration circuit 12 can be easily held at a voltage which is not more than a desired voltage (voltage smaller than the voltage up to which the driving circuit 11 can withstand). For example, when the power supply voltage of the first electric power supply 4 is 12V and the voltage division ratio is 1:1 (e.g., the resistance value of the first resistive element 5 and the resistance value of the second resistive element 191 are respectively 2510, a voltage of about 6V is applied to the control terminal of the power transistor 3, and therefore, a voltage of about 5V is applied to the output terminal OUT.

On the other hand, during a driving state where the electric power of the second electric power supply 6 is supplied to the current driving device 1 (voltage restricting circuit 19B), the voltage of the second voltage level H is input to the third control transistor 193, causing the electric potential of the control terminal of the second control transistor 192 to become a ground potential. In this state, no current flows through the second control transistor 192, and the three-terminal regulator configuration circuit 12 normally controls the output voltage V_{OUT} (regulator operation), as descried in Embodiment 1. At this time, the third control transistor 193 is in ON-state, and therefore, a current flows through the third resistive element 194 and the third control transistor 193. This current is not necessary in the control of the output voltage V_{OUT} executed by the three-terminal regulator configuration circuit 12. It is therefore preferable to minimize a current which could flow through the third resistive element 194 by setting the resistance value of the third resistive element 194 larger.

### Embodiment 3

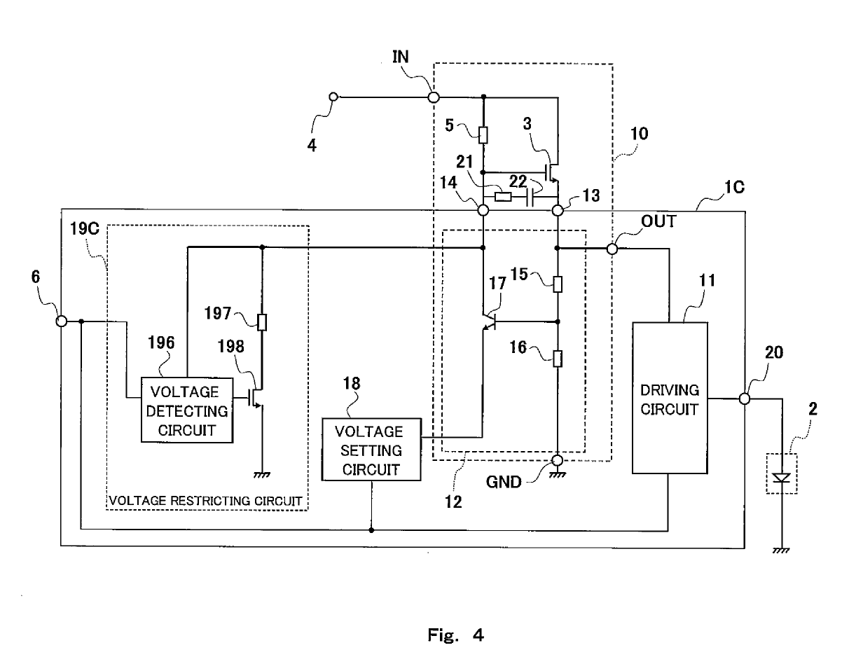

Next, Embodiment 3 of the present invention will be described with reference to FIG. 4. FIG. 4 is a schematic circuit diagram showing an overall configuration of a laser diode system to which a current driving device 1C according to Embodiment 3 of the present invention is applied. In Embodiment 3, the same constituents as those in Embodiment 1 are designated by the same reference symbols and will not be described repetitively.

Referring to FIG. 4, the current driving device 1C of this embodiment is different from the current driving device 1A of Embodiment 1 in that a voltage restricting circuit 19C includes a voltage detecting circuit 196 which is operative by the electric power supplied from the first electric power supply 4 and detects the voltage from the second electric power supply 6, a fourth resistive element 197 having one end connected to the control terminal connection terminal 14, and a fourth control transistor 198, one main terminal (e.g., drain terminal) of which is connected to the other end of the fourth resistive element 197, the other main terminal (e.g., source terminal) of which is connected to a ground, and a control terminal (e.g., gate terminal) of which is connected to the output terminal of the voltage detecting circuit 196, and the voltage detecting circuit 196 is configured to turn ON the fourth control transistor 198 when the detected voltage is less than a threshold voltage. In this embodiment, the fourth control transistor 198 is constituted by a FET.

To be more specific, the fourth resistive element 197 is connected at one end thereof in series with the first resistive element 5 via the control terminal connection terminal 14, and connected at the other end thereof to one main terminal (drain terminal) of the fourth control transistor 198. Thus, the first resistive element 5 and the fourth resistive element 197 constitute a third voltage dividing resistive circuit. The voltage detecting circuit 196 is connected to the control terminal connection terminal 14, and is operative by the electric power supplied from the first electric power supply 4. To be specific, when the voltage detecting circuit 196 does not detect the voltage output from the second electric power supply 6, it switches the voltage level of the fourth control transistor 198 from the first level L to the second level H higher than the first level L by the electric power supplied from the first electric power supply 4, and connects the fourth resistive element 197 to a ground.

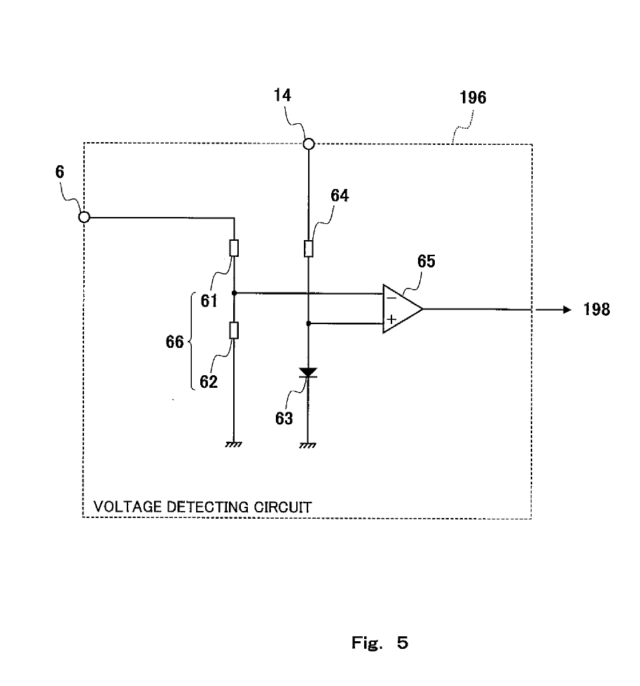

FIG. 5 is a schematic circuit diagram showing a configuration of the voltage detecting circuit 196 of the current driving device 1C of FIG. 4. Referring to FIG. 5, the voltage detecting circuit 196 includes a tenth resistive element 61 and an eleventh resistive element 62 constituting a voltage setting resistive circuit 66 which extracts a predetermined first voltage from the electric power supplied from the second electric power supply 6, a diode 63 which extracts a predetermined second voltage from the electric power supplied from the first electric power supply 4, a twelfth resistive element 64 for restricting a current flowing through the diode 63, and a comparator 65 for comparing the first voltage extracted by the voltage setting resistive circuit 66 to the second voltage extracted by the diode 63. The comparator 65 is connected to the control terminal of the fourth control transistor 198 such that its output is input to the control terminal of the fourth control transistor 198 and is configured to output a signal of the first voltage level L when the first voltage is larger than the second voltage, and output a signal of the second voltage level H when the first voltage is smaller than the second voltage.

In the voltage detecting circuit 196, by the electric power supplied from the first electric power supply 4 via the control terminal connection terminal 14, a current flows through the twelfth resistive element 64 and the diode 63, and the predetermined second voltage which is a reference voltage is applied to the diode 63. In this embodiment, the cathode of the diode 63 is connected to a ground, while the anode of the diode 63 is connected to a non-inverting input terminal (plus side input terminal) of the comparator 56. In this configuration, the voltage applied to the anode of the diode 63 is input to the non-inverting input terminal of the comparator 65 as the second voltage. In the voltage detecting circuit 196, by the electric power supplied from the second electric power supply 6, a current flows through the voltage setting resistive circuit 66 connected in series and a voltage generated by dividing the voltage by the voltage setting resistive circuit 66 is input to the inverting input terminal (minus side input terminal) of the comparator 65 as the first voltage.

The voltage setting resistive circuit 66 and the twelfth resistive element 64 are each set to have a resistance value which allows the first voltage input to the inverting input terminal of the comparator 65, to be larger, preferably much larger than the second voltage input to the non-inverting input terminal of the comparator 56, when the voltage of the electric power supplied from the second electric power supply 6 reaches a voltage (e.g., power supply voltage 5V) during operation of the three-terminal regulator 10. In a state where the first electric power supply 4 is turned ON, but the second electric power supply 6 is not turned ON or the voltage of the electric power supplied from the second electric power supply 6 does not rise yet to a level at which the power transistor 3 can be controlled after the second electric power supply 6 is turned ON, the comparator 65 outputs the signal of the second voltage level H, while in a state where the first electric power supply 4 is turned ON, the second electric power supply 6 is turned ON, and the voltage of the electric power supplied from the second electric power supply 6 has risen to a level at which the power transistor 3 can be controlled, the comparator 65 outputs the signal of the first voltage level L.

In the above configuration, in a state where the second electric power supply 6 is not turned ON or the voltage of the electric power supplied from the second electric power supply 6 does not rise yet to a level at which the power transistor 3 can be controlled after the second electric power supply 6 is turned ON, the voltage at the control terminal of the fourth control transistor 198 becomes the second voltage level H, and therefore the fourth control terminal 197 is turned ON, so that a current flows through the first resistive element 5, the control terminal connection terminal 14, the fourth resistive element 197 and the fourth control transistor 198. Thereby, the voltage generated by dividing the voltage of the first electric power supply 4 by the third voltage dividing resistive circuit is applied to the control terminal of the power transistor 3. The power transistor 3 drops the voltage generated by the voltage dividing in the second voltage dividing resistive circuit, by a threshold voltage of the power transistor 3, and the dropped voltage is output as the output voltage V_{OUT} of the three-terminal regulator configuration circuit 12.

During a non-driving state where the electric power of the second electric power supply 6 is not supplied to the current driving device 1C, the voltage of the first electric power supply 4 is divided by the third voltage dividing resistive circuit (first resistive element 5 and fourth resistive element 197). Therefore, by suitably determining a voltage division ratio (ratio between the resistance value of the first resistive element 5 and the resistance value of the fourth resistive element 197) preliminarily, the output voltage V_{OUT} of the three-terminal regulator configuration circuit 12 can be easily held at a voltage which is not more than a desired voltage (voltage smaller than the voltage up to which the driving circuit 11 can withstand).

On the other hand, during a driving state where the electric power of the second electric power supply 6 is supplied to the current driving device 1C, the voltage detecting circuit 196 outputs the voltage at the first voltage level L to the fourth control transistor 198, causing the fourth transistor 198 to be turned OFF. In this state, no current flows through the fourth resistive element 197. Therefore, the three-terminal regulator 10 normally controls the output voltage V_{OUT} (regulator operation), as descried in Embodiment 1.

### Embodiment 4

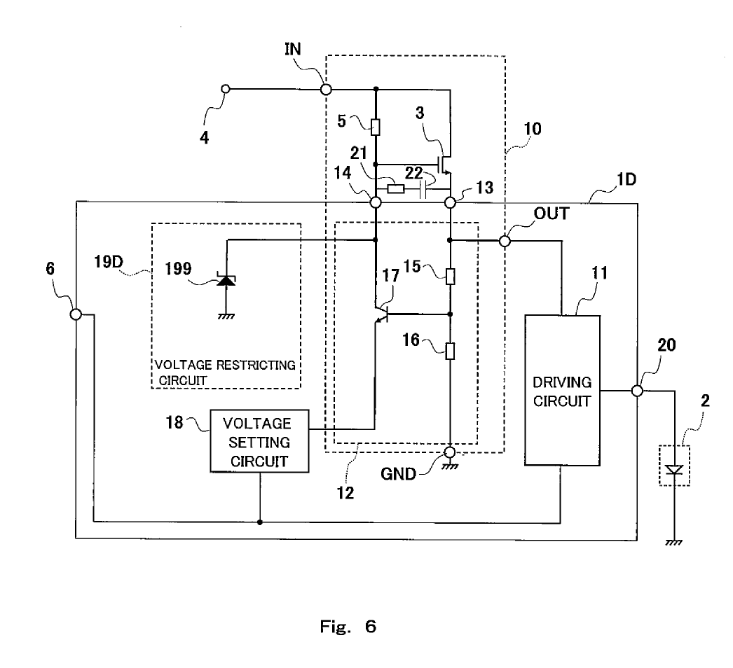

Next, Embodiment 4 of the present invention will be described with reference to FIG. 6. FIG. 6 is a schematic circuit diagram showing an overall configuration of a laser diode system to which a current driving device 1D according to Embodiment 4 of the present invention is applied. In Embodiment 4, the same constituents as those in Embodiment 1 are designated by the same reference symbols and will not be described repetitively.

Referring to FIG. 6, the current driving device 1D of this embodiment is different from the current driving device 1A of Embodiment 1 in that a voltage restricting circuit 19D includes a clamp circuit 199 which is connected to the control terminal connection terminal 14 and holds a control voltage applied to the control terminal of the power transistor 3 at a predetermined voltage, when the control voltage reaches the predetermined voltage or more.

To be specific, the clamp circuit 199 is constituted by, for example, Zener diode. In this configuration, the cathode of the Zener diode 199 is connected to the control terminal connection terminal 14, while the anode of the Zener diode 199 is connected to a ground. The Zener diode 199 is an element which flows a reverse current rapidly when a predetermined reverse voltage (breakdown voltage) is applied thereto. Therefore, by setting the breakdown voltage of the Zener diode 199 to a value which is not more than the control voltage applied to the control terminal of the power transistor 3 at the time when the output voltage V_{OUT} is equal to the voltage up to which the driving circuit 11 can withstand, an avalanche breakdown occurs in the Zener diode 199 and a current flows from the first electric power supply 4 to the first resistive element 5 if a higher voltage (e.g., voltage 12V of the first electric power supply 4) is applied to the control terminal connection terminal 14. This makes it possible to set the voltage applied to the driving circuit 11 to a value which is not more than the voltage up to which the driving circuit 11 can withstand.

As should be appreciated from the above, in accordance with the configuration of this embodiment, the voltage applied to the control terminal of the power transistor 3 is held at a predetermined voltage or less irrespective of whether the second electric power supply 6 is turned ON or OFF. Therefore, with a simple configuration, the output voltage of the three-terminal regulator configuration circuit 12 can be easily held at a desired voltage or less (voltage smaller than the breakdown voltage up to which the driving circuit 11 can withstand).

The clamp circuit 199 is not limited to the Zener diode, but any circuit may be used so long as it holds the voltage at the control terminal of the power transistor 3 at a predetermined voltage when the voltage becomes the predetermined voltage or more.

Thus far, embodiments of the present invention have been described. The present invention is not limited to them, but can be improved, altered or modified, within a scope of the invention. For example, two or more of the above plural embodiments may be combined. Although plural kinds of transistors (FET or bipolar transistor) are combined in the above embodiments, any transistor may be used so long as it can implement the circuit operation as described above.

Although in the above embodiments, the current driving device for driving the laser diode as the driven device has been described, the present invention may be applied to current driving devices for driving another driven devices such as a light-emitting diode (LED), and a motor. Furthermore, the present invention may be applied to uses other than the use in which the current driving device for driving the laser diode as the driven device is applied to the optical disc system, for example, a communication device or a medical device using the laser diode.

The present invention is useful as a current driving device or the like which is capable of supplying a driving voltage to a driving circuit stably and can reduce the number of components.

Numerous modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

What is claimed is:

1. A current driving device comprising:
a main terminal connection terminal connected to a power transistor, one main terminal of which is connected to a first electric power supply and the other main terminal of which is connected to the main terminal connection terminal;
a control terminal connection terminal connected to a control terminal of the power transistor;
a three-terminal regulator configuration circuit configured to change a control voltage corresponding to a target output voltage based on an output voltage, apply the changed control voltage to the control terminal of the power transistor to cause the power transistor to drop a voltage of the first electric power supply, feed-back control the dropped voltage so that the dropped voltage reaches the target output voltage, and output the controlled dropped voltage as the output voltage, in a state where the other main terminal and the control terminal of the power transistor are connected to the main terminal connection terminal and the control terminal connection terminal, respectively;
a driving circuit configured to generate a driving current for driving a driven device using the output voltage;
a voltage setting circuit which is connected to a second electric power supply which outputs a lower voltage than the first electric power supply and sets the control voltage corresponding to the target output voltage which is applied from the three-terminal regulator configuration circuit to the control terminal of the power transistor, using an electric power from the second electric power supply; and
a voltage restricting circuit which is connected to the control terminal connection terminal and holds the control voltage applied to the control terminal of the power transistor so that the output voltage of the three-terminal regulator configuration circuit becomes a predetermined voltage or less, upon an electric power being supplied from the first electric power supply to the voltage restricting circuit.

2. The current driving device according to claim 1,
wherein the control terminal of the power transistor is connected to the first electric power supply via a first resistive element;
the voltage setting circuit is configured to generate a set voltage based on a ground corresponding to the target output voltage using the electric power supplied from the second electric power supply, and apply the generated set voltage to the three-terminal regulator configuration circuit; and
the three-terminal regulator configuration circuit includes:
a first voltage dividing resistive circuit, one end of which is connected to the main terminal connection terminal and the other end of which is connected to a ground, the first voltage resistive circuit being configured to divide the output voltage; and
a first control transistor, one main terminal of which is connected to the control terminal connection terminal, the other main terminal of which is applied with the set voltage of the voltage setting circuit, and a control terminal of which is applied with a voltage generated by voltage dividing in the first voltage dividing resistive circuit.

3. The current driving device according to claim 2,
wherein the voltage restricting circuit includes:
a second resistive element having one end connected to the control terminal connection terminal;
a second control transistor, one main terminal of which is connected to the other end of the second resistive element and the other main terminal of which is connected to a ground; and
a third control transistor, one main terminal of which is connected to the control terminal connection terminal via a third resistive element and to a control terminal of the second control transistor, and the other main terminal of which is connected to a ground, the third control transistor being turned ON to connect the control terminal of the second control transistor to a ground, when the voltage of the second electric power supply is not less than a predetermined voltage.

4. The current driving device according to claim 2,
wherein the voltage restricting circuit includes:
a voltage detecting circuit configured to operate by the electric power supplied from the first electric power supply and detect a voltage supplied from the second electric power supply;
a fourth resistive element having one end connected to the control terminal connection terminal; and
a fourth control transistor, one main terminal of which is connected to the other end of the fourth resistive element, the other main terminal of which is connected to a ground, and a control terminal of which is connected to an output terminal of the voltage detecting circuit;
wherein the voltage detecting circuit is configured to turn ON the fourth control transistor when the voltage detecting circuit detects a voltage less than a predetermined threshold voltage.

5. The current driving device according to claim 2,
wherein the voltage restricting circuit includes:
a clamp circuit connected to the control terminal connection terminal and configured to hold the control voltage applied to the control terminal of the power transistor at a predetermined voltage when the control voltage becomes the predetermined voltage or more.

6. The current driving device according to claim 1,
wherein the main terminal connection terminal, the control terminal connection terminal, the three-terminal regulator configuration circuit, the driving circuit, the voltage setting circuit and the voltage restricting circuit are configured to form one integrated circuit.

7. The current driving device according to claim 1,
wherein the driven device is a laser diode and the driving circuit is a laser current driving circuit for generating a driving current flowing through the laser diode.
